(19) United States
(12) Patent Application Publication
(10) Pub. No.: US 2026/0136133 A1
(43) Pub. Date: May 14, 2026

(54) Proximity Muting for Microphone

(71) Applicant: Shure Acquisition Holdings, Inc., Niles, IL (US)

(72) Inventor: Finlay Jackson, Currie (GB)

(21) Appl. No.: 19/385,398

(22) Filed: Nov. 11, 2025

Related U.S. Application Data
(60) Provisional application No. 63/720,359, filed on Nov. 14, 2024.

(51) Int. Cl. H04R 3/00; G01B 15/00; H04R 1/08

(52) U.S. Cl. CPC H04R 3/002; G01B 15/00; H04R 1/08; H04R 2420/01; H04R 2420/05; H04R 2420/07; H04R 2430/01

(57) ABSTRACT

Aspects of the disclosure relate to an audio system architecture that includes a wireless microphone and a wireless hub in which the microphone may be docked. The audio system may detect the proximate distance of the wireless microphone to the wireless hub. Based on the proximate distance changing and crossing one or more threshold distances, various functions may autonomously be performed, such as muting the microphone prior to the microphone being docked in the wireless hub to avoid unwanted noise.

### CROSS-REFERENCE TO RELATED APPLICATIONS

This application claims priority to U.S. Provisional Patent Application No. 63/720,359, filed Nov. 14, 2024, the entire content of which is hereby incorporated by reference herein in its entirety and for all purposes.

### TECHNICAL FIELD

Aspects of the disclosure relate to an audio system and, more specifically, to the configuration and control of a microphone in an audio system.

### BACKGROUND

An audio system may comprise one or more microphones coupled wirelessly to other devices (e.g., docking stations, receivers, mixers, amplifiers, speakers, etc.). During operation, the microphone(s) and the audio system change between several configurations, such as microphone setup and initialization, charging and discharging of the microphone power source, docking and undocking of the microphone in a station, handoff of the microphone between different users, coordination of audio signal from multiple microphones, etc. The configuration changes may complicate or cause issues with the control of the microphone's operation and functionality.

### SUMMARY

The following presents a simplified summary of the disclosure to provide a basic understanding of some aspects of the disclosure. This summary is not an extensive overview of the disclosure. It is not intended to identify key or critical elements of the invention or to delineate the scope of the invention. The following summary merely presents some disclosure concepts in a simplified form as a prelude to the more detailed description provided below.

Aspects of the disclosure provide reliable, scalable, and effective technical solutions that address and overcome the problems associated with the operation of wireless microphones in audio systems.

An example audio device may comprise a wireless microphone or a hub adapted to communicate with the wireless microphone. The wireless microphone or the hub may comprise at least one processor and memory having computer-executable instructions stored therein. The computer-executable instructions, when executed by the at least one processor, may cause the audio device to: receive an indication of a distance between the wireless microphone and the hub, compare the distance to a predetermined threshold, and based on the comparing, perform one or more audio functions.

The computer-executable instructions, when executed by the at least one processor, may further cause the audio device to: determine, based on the comparing, that the distance between the wireless microphone and the hub decreased below the predetermined threshold; and perform, based on the determination that the distance decreased below the predetermined threshold, the one or more audio functions. The one or more audio functions may include muting the wireless microphone or decreasing a volume of the wireless microphone over a time duration. The one or more audio functions may include muting the wireless microphone by reducing a volume of an audio signal output by the wireless microphone or the hub. The one or more audio functions may include muting the wireless microphone before the wireless microphone contacts the hub.

In an example, the computer-executable instructions, when executed by the at least one processor, may further cause the audio device to: determine, based on the determination that the distance decreased below the predetermined threshold, that the wireless microphone is docked in the hub; detect that the wireless microphone has been undocked from the hub; and increase the volume of the wireless microphone based on the detection that the wireless microphone has been undocked from the hub. In some examples the volume may be increased to a low volume and may be based on the distance being increased.

In some examples, the audio device may comprise an antenna, and the computer-executable instructions, when executed by the at least one processor, may cause the audio device to: detect a strength of a signal received by the antenna; and determine, based on the strength of the signal, the distance between the wireless microphone and the hub.

In certain variations, the computer-executable instructions, when executed by the at least one processor, cause the audio device to: determine, based on the comparing, that the distance between the wireless microphone and the hub increased above the predetermined threshold; and perform, based on the determination that the distance increased above the predetermined threshold, the one or more audio functions. In such variations, the one or more audio functions may include unmuting the wireless microphone or increasing a volume of the microphone over a time duration.

The audio device may include a charging interface configured to transfer power from the hub to the wireless microphone.

Examples include an audio system comprising a wireless microphone and a hub. The wireless microphone may comprise: one or more sound transducers, a base, a first antenna, and first circuitry configured to generate an audio signal based on sound sensed via the one or more sound transducers and transmit the audio signal via the first antenna. The hub may comprise: a slot configured to receive the base of the wireless microphone, a second antenna, a data interface, and second circuitry configured to receive the audio signal from the wireless microphone via the second antenna and transmit audio data based on the received audio signal from the data interface. The first circuitry, the second circuitry, or a combination of the first circuitry and the second circuitry may further be configured to: determine a distance between the wireless microphone and the hub; compare the distance to a predetermined threshold; and based on the comparing, perform one or more audio functions.

In some examples, the first circuitry, the second circuitry, or a combination of the first circuitry and the second circuitry may be configured to: determine, based on the comparing, that the distance between the wireless microphone and the hub decreased below the predetermined threshold; and perform, based on the determination that the distance decreased below the predetermined threshold, the one or more audio functions.

In some examples of the audio system, the one or more audio functions include muting the wireless microphone or decreasing a volume of the wireless microphone over a time duration. The one or more audio functions may include muting the wireless microphone by reducing a volume of the audio signal transmitted from the microphone or the audio data transmitted by the hub. The one or more audio functions may include muting the wireless microphone before the wireless microphone contacts the hub.

In some examples of the audio system, the first circuitry, the second circuitry, or a combination of the first circuitry and the second circuitry may be configured to: determine, based on the determination that the distance decreased below the predetermined threshold, that the wireless microphone is docked in the hub; detect that the wireless microphone has been undocked from the hub; and increase the volume of the wireless microphone based on the detection that the wireless microphone has been undocked from the hub.

In some examples of the audio system, the audio system, the first circuitry, the second circuitry, or a combination of the first circuitry and the second circuitry may be configured to: detect a signal strength of the audio signal received by the second antenna or of another signal exchanged between the first antenna and the second antenna; and determine, based on the signal strength, the distance between the wireless microphone and the hub.

In some examples of the audio system, the first circuitry, the second circuitry, or a combination of the first circuitry and the second circuitry are further configured to: determine, based on the comparing, that the distance between the wireless microphone and the hub increased above the predetermined threshold; and perform, based on the determination that the distance increased above the predetermined threshold, the one or more audio functions. In these examples, the one or more audio functions include unmuting the wireless microphone or increasing a volume of the microphone over a time duration.

In the audio system, the wireless microphone may comprise a battery and a first charging interface configured to receive power via the base of the wireless microphone and charge the battery. The hub may comprise a second charging interface configured to provide the power via the slot to the first charging interface of the wireless microphone.

Some examples include a method of controlling a wireless microphone or a hub adapted to communicate with the wireless microphone. The method may comprise: receiving an indication of a distance between the wireless microphone and the hub; comparing the distance to a predetermined threshold; and performing, by the wireless microphone or the hub, one or more audio functions based on the comparing. The method may further comprise determining, based on the comparing, that the distance between the wireless microphone and the hub decreased below the predetermined threshold; and performing, based on the determining that the distance decreased below the predetermined threshold, the one or more audio functions.

In such methods, the one or more audio functions may include muting the wireless microphone or decreasing a volume of the wireless microphone over a time duration; muting the wireless microphone by reducing a volume of an audio signal output by the wireless microphone or the hub; or muting the wireless microphone before the wireless microphone contacts the hub.

The method may further comprise: determining, based on the determining that the distance decreased below the predetermined threshold, that the wireless microphone is docked in the hub; detecting that the wireless microphone has been undocked from the hub; and increasing the volume of the wireless microphone based on the detecting that the wireless microphone has been undocked from the hub.

In some examples, the method may comprise: detecting a strength of a signal transmitted between the wireless microphone and the hub; and determining, based on the strength of the signal, the distance between the wireless microphone and the hub.

Some examples of the method include: determining, based on the comparing, that the distance between the wireless microphone and the hub increased above the predetermined threshold; and performing, based on the determining that the distance increased above the predetermined threshold, the one or more audio functions. In such examples, the one or more audio functions include unmuting the wireless microphone or increasing a volume of the microphone over a time duration. Some examples also include transferring power from the hub to the wireless microphone.

An example method implemented with an audio system may include generating, with a wireless microphone, an audio signal based on sound sensed via one or more sound transducers; transmitting the audio signal via a first antenna in the wireless microphone; receiving, via a second antenna in a hub, the audio signal transmitted via the first antenna in the wireless microphone; transmitting audio data from a data interface in the hub based on the audio signal received via the second antenna; determining, by the wireless microphone or the hub, a distance between the wireless microphone and the hub; comparing the distance to a predetermined threshold; and performing, by the wireless microphone or the hub, one or more audio functions based on the comparing.

The example method implemented with the audio system may comprise determining, based on the comparing, that the distance between the wireless microphone and the hub decreased below the predetermined threshold; and performing, based on the determining that the distance decreased below the predetermined threshold, the one or more audio functions. The one or more audio functions in this method may include muting the wireless microphone or decreasing a volume of the wireless microphone over a time duration; muting the wireless microphone by reducing a volume of the audio signal transmitted from the microphone or the audio data transmitted by the hub; or muting the wireless microphone before the wireless microphone contacts the hub.

The example method implemented with the audio system may comprise determining, based on the determining that the distance decreased below the predetermined threshold, that the wireless microphone is docked in the hub; detecting that the wireless microphone has been undocked from the hub; and increasing the volume of the wireless microphone based on the detection that the wireless microphone has been undocked from the hub.

Some variations of the example method implemented with the audio system may comprise detecting a signal strength of the audio signal received by the second antenna or of another signal exchanged between the first antenna and the second antenna; and determining, based on the signal strength, the distance between the wireless microphone and the hub.

The example method implemented with the audio system may comprise determining, based on the comparing, that the distance between the wireless microphone and the hub increased above the predetermined threshold; and performing, based on the determining that the distance increased above the predetermined threshold, the one or more audio functions. In such an example, the one or more audio functions include unmuting the wireless microphone or increasing a volume of the microphone over a time duration.

Some example methods implemented with the audio system may include transmitting power via a first charging interface in a slot of the hub; and receiving the power via a second charging interface in a base of the wireless microphone docked in the slot of the hub.

These, as well as other novel advantages, details, examples, features, and objects of the present disclosure, will be apparent to those skilled in the art from following the detailed description, the attached claims, and accompanying drawings listed herein, which are helpful in explaining the concepts discussed herein.

### BRIEF DESCRIPTION OF THE DRAWINGS

The present disclosure is illustrated by way of example and not limited in the accompanying figures in which like reference numerals indicate similar elements and in which:

FIGS. 1A and 1B show example components and the use of a wireless microphone audio system.

FIG. 2 shows an example of audio signals produced by a wireless microphone audio system.

FIG. 3 shows examples of electrical block diagrams of components of a wireless microphone audio system.

FIGS. 4A-4D show example methods of wireless microphone control.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

Audio systems often comprise a chain of discrete subcomponents, each configured to perform a specific audio processing functionality. For example, the subcomponents may include microphones, receivers, mixers, amplifiers, speakers, personal monitoring devices, musical instruments, general-purpose computing devices, etc. For example, a system may receive audio from one or more microphones and process the audio via a receiver, a mixer, and/or amplifier(s) before outputting the audio via one or more speakers. Such a system is often hardwired (e.g., via XLR connections) limiting its flexibility. Larger systems that may often comprise a plurality (e.g., dozens) of microphones and speakers interspersed with multiple amplifiers and speakers may be complex to set up, use, dismantle, and/or troubleshoot.

For example, an audio system may comprise a receiver (e.g., a microphone), output from which may be connected (e.g., via cables) to a device that may amplify and/or trim the output. The amplified/trimmed signal may then be fed to one or more audio processing devices (e.g., an audio mixer) that may be used to consolidate multiple audio signals, process the signals (e.g., perform equalization, add effects, adjust levels, etc.) and provide output via one or more channels. Using multiple devices in the system may require careful consideration of compatibility between the devices and may result in added complexity due to the use of wired connections/adapters to connect the devices. This may be challenging for a novice user.

Further, traditional audio systems, as put together at a location, may only be meant to perform a specific task. For example, a recording system that comprises multiple microphones capturing audio input that is meant to be processed and stored locally may not be easily repurposed for other associated applications (e.g., live-streaming audio, outputting audio for the in-location audience) without substantial modification to its architecture. As a result, a single location may often have multiple audio systems, each configured for a specific task, adding to cost, complexity, and redundancy.

Various examples herein describe an audio system comprising a wireless hub that may be connected to one or more other audio devices (e.g., microphones, speakers, musical instruments and/or instrument outputs, transmitters, receivers, transceivers, computing devices, etc.). The wireless hub may be flexibly configured (e.g., via an associated computing device) to receive audio input from one or more microphones (and/or one or more other audio sources) and send the audio out to one or more other devices (e.g., speakers, user computing devices, streaming devices, etc.). In addition, the user computing device may comprise applications for enabling audio processing tasks (e.g., mixing, noise reduction, equalization (EQ), recording, live-streaming, etc.) reducing the requirement for multiple external special-purpose devices. In one or more examples, the wireless hub may be integrated into an audio device (e.g., a microphone, a speaker, a computing device, or any other input/output device). In this manner, an integrated approach, as described herein, may simplify setting up/modifying the system, enhance system flexibility, and improve overall user experience.

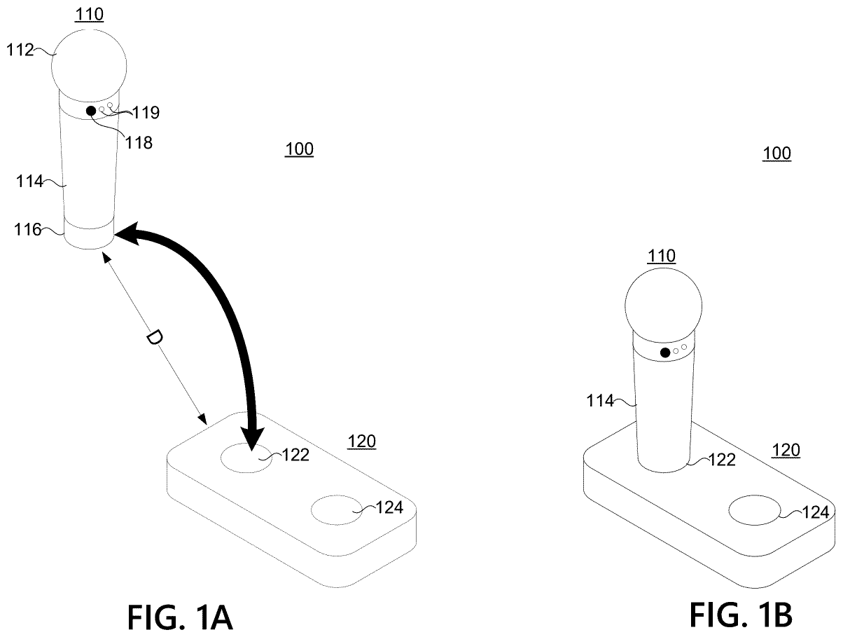

FIG. 1A and FIG. 1B show example components in an audio system 100. Audio system 100 may comprise one or more wireless microphones 110 and a wireless hub 120 (also referred to herein as a dock). Microphone 110 may be used to sense sound, convert the sound to audio signals, and send the audio signals wirelessly to hub 120. Wireless hub 120 may wireless communicate with microphone 110, for example, to control the functions of the microphone and/or to receive audio signals from the microphone and provide those signals to other components of an audio system, such as amplifiers, mixers, speakers, recording devices, speakers, etc. The wireless hub 120 may be powered via a power cord (not shown) (e.g., that may be connected to a wall outlet) and/or may be battery-powered. In an arrangement, the wireless hub 120 may comprise a rechargeable battery that may be charged via the power cord 125.

The audio system 100 may additionally comprise one or more user devices (not illustrated) configured to connect with and control microphones 110 and wireless hub 120. For example, user devices may include smartphones, tablet computers, remote control devices, desktop computers, etc.

Each microphone 110 may comprise a pickup 112 adapted to convert sound into electrical signals. The pickup 112 may include a single or array of sound transducers of any type, such as condenser (e.g., including large-diaphragm and small-diaphragm and electret condenser), dynamic (e.g., including moving coil and ribbon microphones), and/or micro-electromechanical systems (MEMS), among others. The microphone transducers in pickup 112 may be constructed according to one or more geometries (e.g., round, oval, elliptical, rectangular, etc.). The transducers in pickup 112 may individually or collectively have unidirectional, cardioid, supercardioid, hypercardioid, and/or bidirectional pickup patterns. Pickup 112 may also include a cover or grill over the microphone transducers.

Microphone 110 may include a handle 114 attached to the pickup 112. Handle 114 may be constructed according to any number of shapes or geometries (e.g., ergonomic geometries) adapted for handheld use and/or for mounting in a fixture, such as a microphone stand, camera stand, tripod, etc. Handle 114 may house some or all of the electronic components of microphone 110 as further described herein.

Microphone 110 may be configured with one or more user inputs 118 (e.g., buttons, capacitive sensors, accelerometers, etc.) and/or one or more indicators 119 (e.g., lights, haptic actuators, buzzers, speakers, etc.). Inputs 118 may be activated (e.g., pushed, held down, toggled, moved, etc.) to activate and/or turn on the microphone 110, to pair microphone 110 with wireless hub 120, to control the volume of audio signals, and/or control other function of microphone 110. Indicators 119 may indicate the state or operating mode of the microphone 110. For example, the microphone may comprise a power button, activation of which may result in powering on or activating the microphone and activating a power indicator (e.g., a green LED). As another example, the microphone may comprise a mute button, activation of which may result in muting the microphone and activation of a mute indicator (e.g., a red LED) on the microphone.

Microphone 110 may include a base 116 (e.g., a charging base) adapted to interface with wireless hub 120 via electrical contact or wirelessly (e.g., inductively) for charging an internal battery within microphone 110. For example, microphone 110 may be charged by placing it on or attaching it to wireless hub 120. For example, the wireless hub may include one or more slots (e.g., 122, 124), in which charging base 116 may be inserted to support microphone 110 and establish one or more electrical connections. For example, placing base 116 of microphone 110 into slot 122 may cause the attachment of a charging port (e.g., a USB connector) located within the slot to another port located on microphone 110. In another example, slot 116 may include inductive coils that inductively interface with corresponding inductive coils in base 116 to transfer electrical power from hub 120 to microphone 110.

Microphone 110 may require pairing with wireless hub 120 to establish a connection, which may be initiated by bringing the microphone 110 within close proximity to wireless hub 120 or by docking the microphone 110 on or in wireless hub 120 (e.g., setting the base 116 of the microphone into charging slot 122)

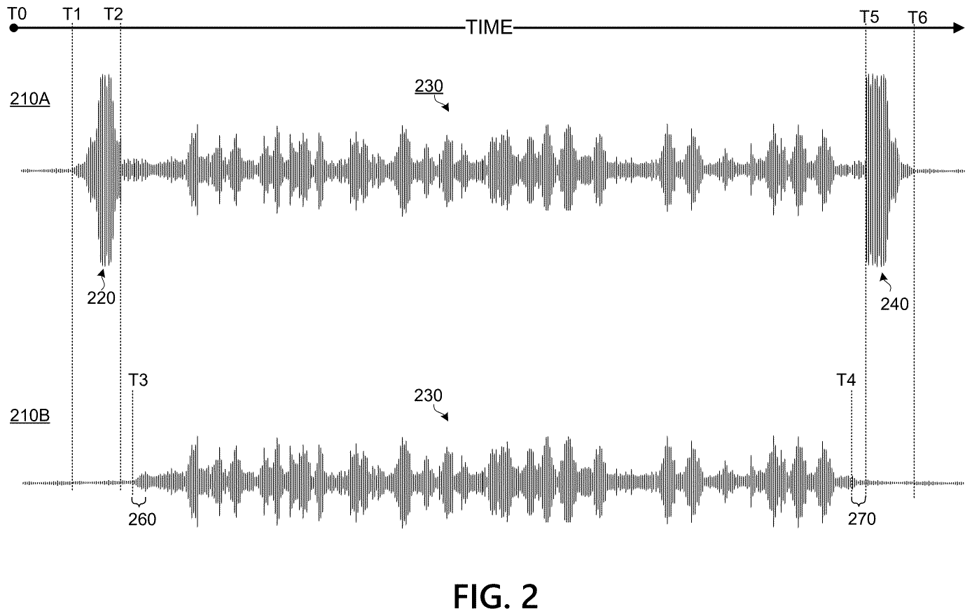

As further described below, microphone 110 and/or hub 120 may sense a distance D (e.g., a radial distance) between microphone 110 and hub 120 and, based on the distance, perform one or more functions of the microphone 110 and/or hub 120. For example, FIG. 2 illustrates audio data produced by microphone 110 and/or hub 120 when performing an autonomous mute function based on microphone 110 being within a threshold distance to hub 120. This function may eliminate the generation of audible noise associated with placing or securing the microphone 110 in a slot (e.g., 122) of hub 120.

Referring to FIG. 2, audio signal streams 210A and 210B may be generated by microphone 110 and/or hub 120. The vertical axis represents the amplitude of the signal, and the horizontal axis represents time starting at T0 on the left. Audio signals streams 210A and 210B may be identical, except that 210B has been processed with a muting function based on proximate distance (e.g., distance D in FIG. 1A) of microphone 110 to hub 120.

Referring to audio signal stream 210A, microphone 110 is positioned in a slot (e.g., 122) of hub 120 at time T0 and may be unmuted. At time T1, a user begins to remove the microphone 110 from the slot, during which the handling of the microphone (e.g., gripping the pickup 112 or handle 114) and the contact between the base 116 of the microphone and the slot 122 (e.g., friction, banging, rattling, disconnection of a port, etc.) causes noise and/or vibration, which is sensed by pickup 112, resulting in the generation of a noisy audible signal 220. As shown, the amplitude (e.g., magnitude) of the noisy audible signal 220 may be high (e.g., large), which may cause a loud and/or unpleasant noise when the audible signal is reproduced through speakers. In some examples, the amplitude may saturate or otherwise exceed the capability of some components of the audio system, such as amplifiers and speakers, which may result in distortion of the produced sound and/or damage to the components. The noise may mask other sounds that pickup 112 might have otherwise sensed.

At time T2, the microphone may be removed entirely from the slot, at which point the noisy audible signal 220 ends. At this time, pickup 112 may begin and continue to sense the user's voice or other sounds 230 in the proximity of the microphone until the user places the microphone 110 back into the slot of hub 120 at time T5.

Starting at time T5, the handling of the microphone (e.g., gripping the pickup 112 or handle 114) and the contact between base 116 of the microphone and slot 122 (e.g., friction, banging, rattling, disconnection of a port, etc.) may once again cause noise and/or vibration, which is sensed by pickup 112. This generates a noisy audible signal 240, similar to the noisy audible signal 230, and may cause the same issues.

Referring now to audible signal stream 210B, in some examples, microphone 110 and/or hub 120 may implement an autonomous mute function based on the distance between microphone 110 and hub 120. For example, starting time T0, the audio output of the microphone 110 and/or hub 120 may be muted while the microphone 110 is docked in slot 122 from time T0 to time T1 and remain muted until the microphone 110 is removed from slot 122 (from time T1 to T2) and exceeds a threshold distance (e.g., a first threshold distance, an unmute threshold distance) from hub 120 at time T3. Once the distance of microphone 110 from hub 120 exceeds the threshold distance, microphone 110 and/or hub 120 is autonomously unmuted and/or set to a low volume.

In some examples, as the user returns the microphone 110 to slot 122 and is less than a threshold distance (e.g., a second threshold distance, a mute threshold distance) at time T4, microphone 110 and/or hub 120 may be autonomously muted. As shown, the autonomous mute function may eliminate noisy audible signal 220 and/or noisy audible signal 240 based on the first and the second threshold distances, respectively.

In some variations, additional actions or modifications to the audible signal stream 210B may be made based on the microphone distance transitioning above or being above the first threshold distance or transitioning below or being below the second threshold distance. For example, microphone 110 and/or hub 120 may control the volume of the audible signal 230 for a time period 260 after the microphone 210 exceeds the first threshold distance or for a time period 270 after the microphone 210 goes below the second threshold distance. For example, microphone 110 and/or hub 120 may increase the volume linearly or according to some other function over the duration of time period 260. Similarly, microphone 110 and/or hub 120 may decrease the volume linearly or according to some other function over the duration of time period 270.

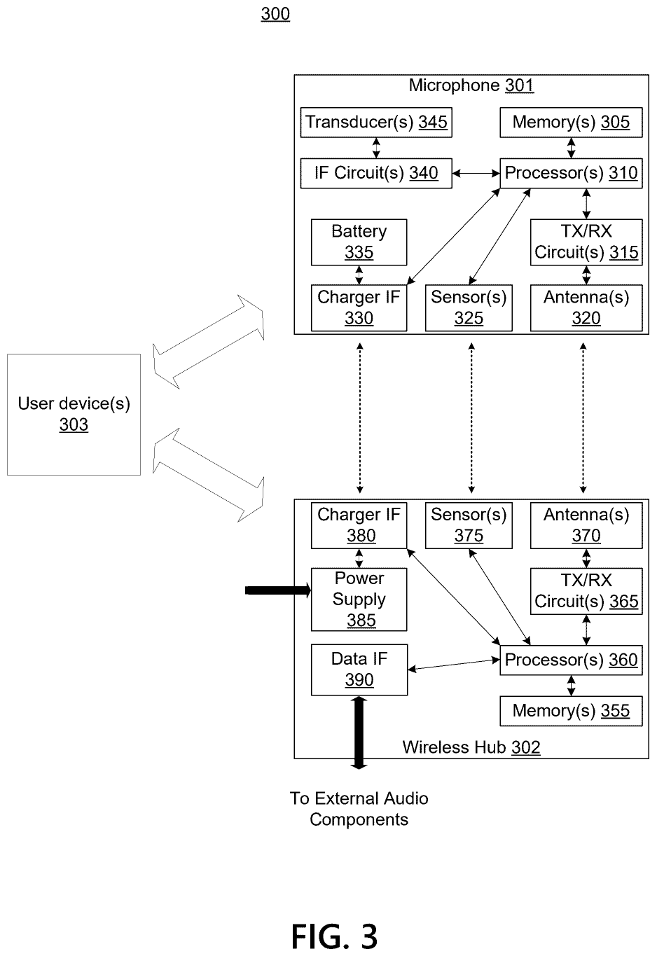

FIG. 3 shows an example audio system 300, including a microphone 301, a wireless hub 302, and a user device 303. For example, microphone 301 may correspond to microphone 110, and wireless hub 302 may correspond to wireless hub 120. While FIG. 3 illustrates only a single microphone 301, a single wireless hub 302, and a single user device 303, system 300 may include any number of microphones 301, wireless hubs 302, and user devices 303 capable of communicating with any other microphone 301, wireless hub 302, or user device 303 in the system.

The microphone 301 may comprise one or more processor(s) 310, transmit/receive (TX/RX) circuit(s) 315, and/or memory 305. The microphone 301 may be implemented using one or more integrated circuits (ICs), software, or a combination thereof, configured to operate as described herein. The Memory 305 may comprise any memory such as a random-access memory (RAM), a read-only memory (ROM), a flash memory, or any other electronically readable memory, or the like. The processor(s) 310 of the microphone 301 may be configured to execute machine-readable instructions stored in memory 305 to perform one or more operations described herein.

Microphone 301 may include one or more sound transducers 345 (e.g., corresponding to transducer(s) 112), such as large-diaphragm and small-diaphragm and electret condenser), dynamic microphones, moving coil microphones, ribbon microphones, and/or micro-electromechanical (MEMS) transducers. The sound transducer(s) 345 may individually or collectively have unidirectional, cardioid, supercardioid, hypercardioid, and/or bidirectional pickup patterns. Interface (IF) circuits 340 in microphone 301 may receive electrical signals generated by transducer(s) 345 that are representative of sound picked up by transducer(s) 345 and convert those signals into digital audio signals output to processor 310. IF circuits 340 may include amplifiers, buffers, analog-to-digital converters, and other components used to convert the analog signals from transducers 345 to digital signals readable by processor 310.

Microphone 301 may further include transmit-receive (Tx/Rx) circuits 315 coupled to one or more antennas 320. One or more data buses may interconnect the processor(s) 310, the TX/RX circuit(s) 315, and/or the memory 305. Processor 310 may be configured to wirelessly exchange information via transmit-receive circuits 315 and antenna(s) 320 to and from wireless hub 302 and/or user devices 303. For example, processor 310 of microphone 301 may receive digital audio signals from IF circuits 340 and transmit those signals wirelessly via antenna 320 to wireless hub 302. Prior to transmitting the digital audio signals to wireless hub 302, processor(s) 310 may process or manipulate the signals (such as controlling the volume of the signal or muting the signal). Processor 310 may additionally or alternatively receive information wirelessly via antenna 320 from wireless hub 320, such as control information, configuration information, commands (e.g., on-off, mute-unmute, volume up-down, etc.), firmware/software updates, etc.

Signals transmitted from and/or received by the microphone 301 may be encoded in one or more data units. For example, the processor(s) 310 may be configured to generate data units and process received data units that conform to any suitable wired and/or wireless communication protocol. The TX/RX circuit(s) 315 may be configured to send/receive signals using one or more communication protocols (e.g., Bluetooth protocol, an Institution of Electrical and Electronics Engineers (IEEE) 802.11 WIFI protocol, a 3^{rd} Generation Partnership Project (3GPP) cellular protocol, a local area network (LAN) protocol, a hypertext transfer protocol (HTTP), etc.).

The microphone 301 may further include a battery 335, configured to power the electrical components of the microphone, and a charger interface (IF) 330, configured to receive electrical power from an external source and transfer the power to charge the battery 335. For example, charger IF 330 may include a charging port (e.g., a USB connector) or inductive coils that inductively receive electrical power from an external source.

Microphone 301 may also include sensors 325 that, for example, may sense or measure proximity (e.g., distance) of the microphone to wireless hub 302. For example, sensors 325 may include inductive, capacitive (e.g., capaciflector), ultrasonic, magnetic, optical, etc. sensors. Sensor(s) 325 may include an accelerometer that can detect the motion of the microphone 301 (e.g., of a user docking (or about to dock) the microphone in wireless hub 302 or detect contact with the wireless hub 302 or detect the microphone being dropped). Sensors 325 may also include circuits configured to measure the strength of an RF or other communication signal received by antenna 320 from wireless hub 302. The proximity or distance of microphone 301 to wireless hub 302 may be correlated to or derived from the signal strength. Such sensors may be embedded in or form part of TX/RX circuit 315.

Wireless hub 302 may include similar processing components to that of microphone 301 and may be configured to operate as a wireless interface between microphone 301 and the remainder of the audio system (e.g., amplifiers, speakers, etc.). Wireless hub may include one or more of processor(s) 360, transmit/receive (TX/RX) circuit(s) 365, and/or memory 365, which may be the same or similar to processor(s) 310, TX/RX circuit(s) 315, and memory 315 of microphone 301. The wireless hub 302 may be implemented using one or more integrated circuits (ICs), software, or a combination thereof, configured to operate as described herein. Memory 365 may comprise any memory, such as random-access memory (RAM), read-only memory (ROM), flash memory, or any other electronically readable memory, or the like. The processor(s) 360 of the wireless hub 302 may be configured to execute machine-readable instructions stored in memory 305 to perform one or more operations described herein.

Wireless hub 302 may further include transmit-receive (Tx/Rx) circuits 365 coupled to one or more antennas 370. One or more data buses may interconnect the processor(s) 360, the TX/RX circuit(s) 365, and/or the memory 365. Processor 360 may be configured to wirelessly exchange information via transmit-receive circuits 365 and antenna(s) 370 to and from microphone 301 and/or user devices 303. For example, processor 360 of wireless hub 302 may wirelessly receive digital audio signals from microphone 301 via antenna 370. Processor 360 may then transmit those signals (wired or wirelessly) to other components of the audio system via a data interface (IF) 390. Prior to transmitting the digital audio signals via data IF 390, processor(s) 360 may process or manipulate the signals (such as converting the signals to audio data in another format, controlling the volume of the audio signal or the audio data, or muting the audio signal or the audio data). Processor 360 may additionally or alternatively transmit information wirelessly via antenna 370 from microphone 310, such as control information, configuration information, commands (e.g., on-off, mute-unmute, volume up-down, etc.), firmware/software updates, etc.

As described above with respect to microphone 301, signals transmitted from and/or received by the wireless hub 302 may be encoded in one or more data units. For example, the processor(s) 360 may be configured to generate data units and process received data units that conform to any suitable wired and/or wireless communication protocol. The TX/RX circuit(s) 365 may be configured to send/receive signals using one or more communication protocols (e.g., Bluetooth protocol, an Institution of Electrical and Electronics Engineers (IEEE) 802.11 WIFI protocol, a 3^{rd} Generation Partnership Project (3GPP) cellular protocol, a local area network (LAN) protocol, a hypertext transfer protocol (HTTP), etc.). The TX/RX circuit(s) 315 and 365 may be configured to send/receive signals using proprietary or non-proprietary communication standards, for example, using channels that are designated as industrial, scientific, and medical (ISM) bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, etc.). Communication between the devices in the audio system may be via (e.g., one or more channels within) a very high frequency (VHF) band (e.g., 30 MHz-300 MHz band) and/or via (e.g., one or more channels within) an ultra-high frequency (UHF) band (e.g., 300 MHz-3 GHz).

The wireless hub 302 may further include a power supply 385 configured to receive electrical power from an external source power (e.g., an AC outlet via a power cord), condition the power (e.g., convert to DC power) for use by the electrical components of the wireless hub 302. Power supply 385 may provide conditioned power to a charger interface 380 configured to transfer the conditioned power to microphone 301 (e.g., via the charger IF 330 in microphone 301). For example, charger IF 380 may include a charging port (e.g., a USB connector) or inductive coils that inductively transmit electrical power to corresponding coils in the charger IF 330 of microphone 301.

Wireless hub 302 may also include sensor(s) 375 that, for example, may sense or measure proximity (e.g., distance) of microphone 301 to wireless hub 302. Like sensors 325 in microphone 301, sensors 375 may include inductive, capacitive (e.g., capaciflector), ultrasonic, magnetic, optical, etc. sensors. Sensor(s) 375 may include an accelerometer that can detect contact of microphone 301 with the wireless hub 302. Sensors 375 may also include circuits configured to measure the strength of an RF or other communication signal received by antenna 370 from microphone 301. The proximity or distance of microphone 3301 to wireless hub 302 may be correlated to or derived from the signal strength. Such sensors may be embedded in or form part of TX/RX circuit 375. Each sensor 325 in microphone 301 may have a corresponding sensor 375 in wireless hub 302, which together sense the proximity or distance between the microphone and the hub.

In one or more examples, microphone 301 and/or the wireless hub 302 may communicate with one or more user devices 303 (e.g., via antennas 320 and 370, respectively). User device 303 may include smartphones, tablet computers, remote control devices, desktop computers, etc., and include similar components (e.g., processors, memory, TX/RX circuits, antennas, etc.) to the microphone and wireless hub for communicating and processing information. The user device(s) 303 may transmit and receive information wirelessly via antenna 320 to/from microphone 301 and wireless hub 320, such as control and status information, configuration information, commands (e.g., on-off, mute-unmute, volume up-down, mixing, equalization, etc.), firmware/software updates, etc. User device 303 may be configured with audio processing and control applications for sending and receiving the information. In some embodiments, a user device 303 may operate and perform the functions of wireless hub 302 for receiving audio signals from microphone 301, processing the signals, and sending the signals to other components of the audio system.

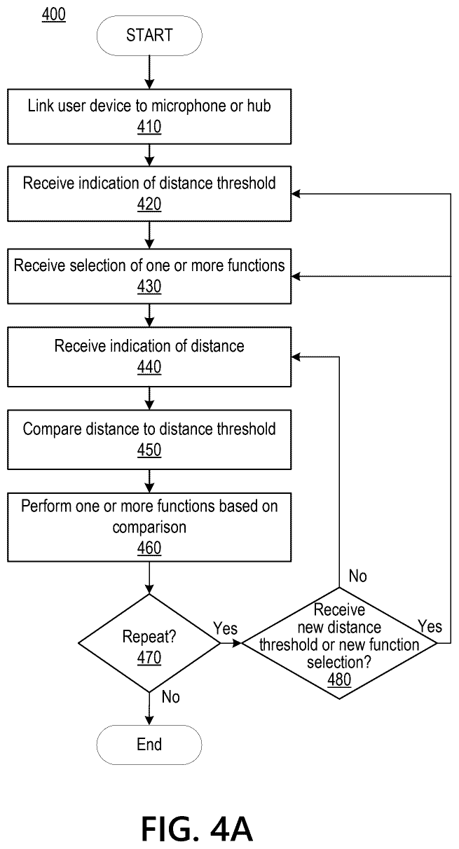

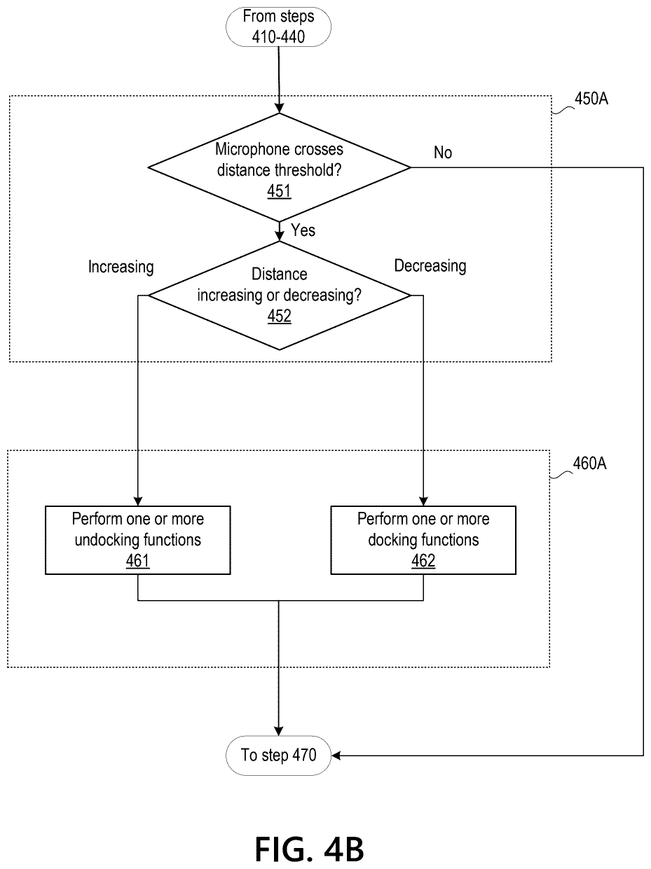

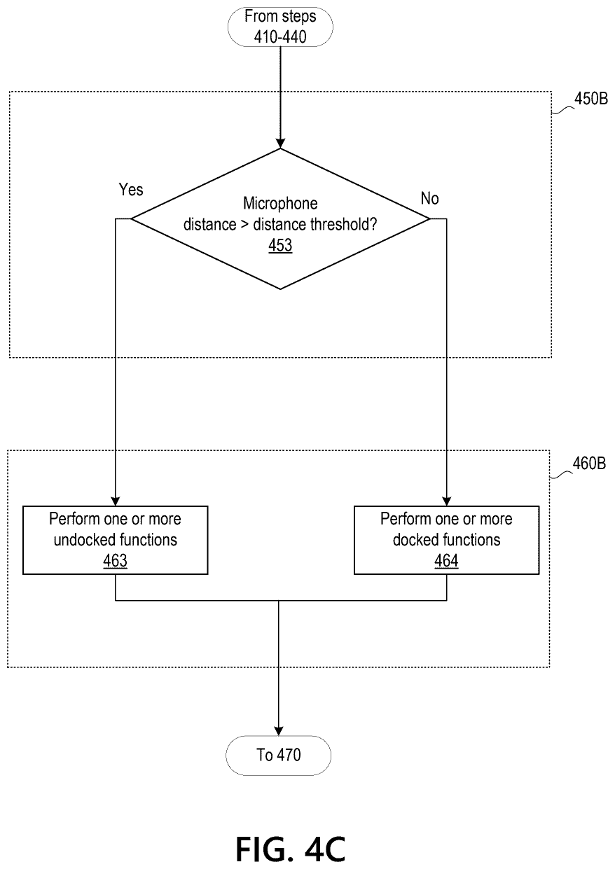

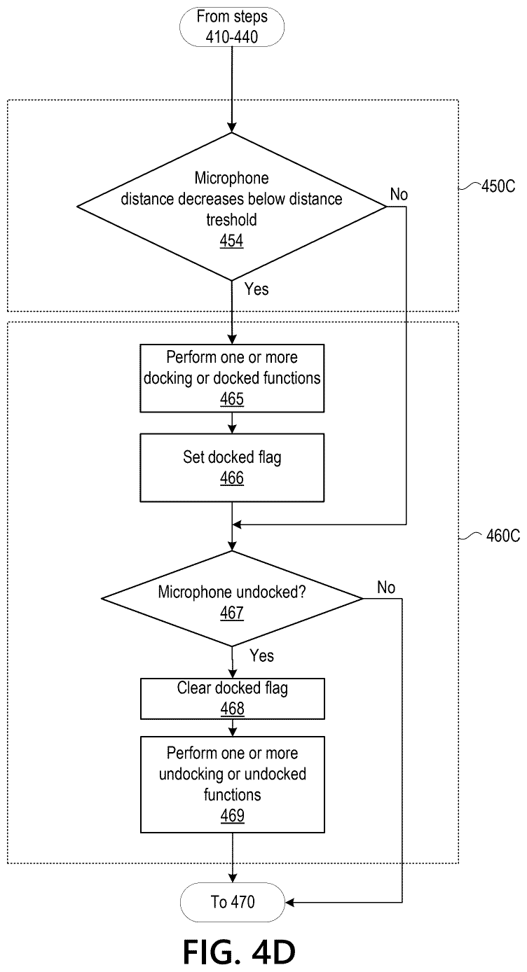

FIG. 4A shows an example method 400 of operation of an audio system such as 100 or 300, which includes a wireless microphone and wireless hub. Method 400 detects the distance between the microphone and the wireless hub and, based on the distance, triggers one or more functions performed by the wireless microphone or wireless hub.

Method 400 may include step 410, in which a user device (e.g., user device 303) may be linked to a wireless microphone (e.g., 110, 301) and/or a wireless hub (e.g., 120, 302). For example, a user device, such as a cell phone or computer, could establish a peer-to-peer network link using a Bluetooth protocol, or each could be linked together through a wireless local area network (LAN) such that the user device may send commands or receive telemetry to and from the wireless microphone or wireless hub.

At step 420, the wireless microphone and/or the wireless hub may receive (e.g., from the user device via the link) an indication of one or more distance thresholds (e.g., the first and second thresholds, mute and un-mute thresholds discussed above with respect to FIG. 2). Each threshold may be indicated in the form of a distance (e.g., 2 cm) or in the form of a sensor value (e.g., from sensors 325 and/or 375) which corresponds to distance. For example, the indication may be in the form of a signal strength measurement of RF signals (e.g., milliwatts, dBm) between the microphone and the hub (e.g., between antennas 320 and 370), where higher signal strength correlates to a closer distance. In some examples, the distance threshold may be zero.

At step 430, the wireless microphone and/or the wireless hub may receive (e.g., from the user device via the link) an indication of one or more functions to be performed based on the distance between the microphone and the wireless hub. For example, the functions may relate to muting and/or unmuting the volume of the audio signal output by the microphone and/or hub. The muting and/or unmuting may be with respect to all audio signals or may be selective with respect to certain channels (e.g., certain speakers) to which the audio signal is provided. In other examples, the function may relate to controlling the volume, for example, as described with respect to 260 and 270 in FIG. 2. For example, the function may fade out or fade in (e.g., increase or reduce) the volume over time. Other functions include turning on/off the microphone or controlling other parts of the system. In one example, the function may join and/or end a video call, where the microphone is used for communication on the call.

In some examples, method 400 does not include steps 410, 420, and/or 430, and the one or more thresholds and/or the one or more functions may be pre-programmed into the wireless microphone and/or wireless hub (e.g., stored in memories 305 and/or 355).

At step 440, during operation, the microphone and/or the wireless hub may receive an indication of the proximate distance between the microphone and the hub. For example, a user may be handling a microphone by removing the microphone from the slot in the hub or by placing the microphone back into the slot. As previously described in effect FIG. 3, the distance may be sensed by sensors and received by a processor in the microphone and/or in the hub. Additionally, in step 440, the microphone and/or the hub may sense whether the microphone is moving toward the hub.

At step 450, the microphone and/or the hub may compare the indication of the distance to the one or more distance thresholds received in step 420. For example, the microphone and/or the hub may sense that the distance is more (greater) than a first distance threshold or sense a transition from being less to being more than (e.g., exceeding) the first distance threshold, indicating that the microphone is moving further away from the hub. In another example, the microphone and/or the hub may sense that the distance is less than a second distance threshold or sense a transition from being more to being less than the second distance threshold, indicating that the microphone is getting closer to the hub period. In other examples, the microphone and/or the hub may detect contact between the microphone and the hub, indicating that the distance is zero period. In some examples, the first threshold and the second threshold may be the same.

At step 460, the microphone and/or the wireless hub may perform the one or more functions received in step 430 based on the comparison performed in step 450. For example, as discussed with respect to FIG. 2, the microphone and/or the wireless hub may detect that the microphone moves within a threshold distance (e.g., radius) to the hub and, based on this determination, mute the microphone. Similarly, the microphone and/or the wireless hub may detect that the microphone is removed from the slot in the hub and/or moves away from the hub by a threshold distance and, based on that determination, unmute the microphone and/or increase the microphone to a low or threshold volume. The microphone and/or the hub may perform any function that the microphone and/or the hub are capable of based on the comparison of the distance to a threshold. For example, the microphone may be powered off when it is moved within a threshold distance to the slot of the hub, or output to certain speakers may be attenuated or maybe attenuated or faded out as the microphone moves closer to the hub.

At step 470, the microphone and/or the hub may determine whether to repeat the process. For example, the microphone and/or the hub may determine to not repeat the process based on determining that the microphone is no longer in use. For example, the microphone and/or the hub may detect that the microphone is no longer in use based on the user turning the microphone off or to standby. In some examples, the microphone and/or the hub may detect that the microphone is no longer in use based on no audio being sensed by the microphone over a predetermined period of time (e.g. auto standby), or that the microphone has not moved over a predetermined period of time (e.g., as sensed by an accelerometer). If the microphone and/or the hub may determine not to repeat the process, the process ends. If the microphone and/or the hub determines to repeat the process, e.g., because the microphone is still being used, the process proceeds to step 480

At step 480, the microphone and/or the hub may determine whether any new proximate distance thresholds or new functions are selected, for example, as discussed above with respect to steps 420 and 430. If you're new thresholds or functions are selected, the process may return to step 440 to receive another indication of the approximate distance between the microphone in the hub and to repeat steps 450 and 460 continually and/or in real-time to detect whether the microphone moves within or outside approximate distance to the hub and perform corresponding functions related to that detection. If at step 480, a new approximate distance and/or a new function is detected as being selected, the process may return to steps 420 and/or 4:30 to receive those new values before repeating steps 440 through 460.

Each of the steps in process 400 may be performed by the microphone, by the wireless hub, or by a combination of the microphone and the wireless hub. For example, for the muting function, the microphone may mute the audio signal transmitted from the microphone to the wireless hub, or the wireless hub may receive the audio signal unmuted and then subsequently mute the output of the audio signal (via data IF 390) to the other devices of the audio system. In another example, one device (e.g., the microphone) may perform certain steps and transmit the relevant data to the other device (e.g., the hub) to perform the remainder of the steps. For example, the hub may perform steps 410, 420, and/or 430 to determine a proximate distance threshold and a function to perform and then transmit that information to the microphone, which the microphone may use then to perform steps 440, 450, and/or 460 to sense the distance, compare the distance to the threshold, and perform the function based on the comparison. The steps may be performed by any combination of the hub and the microphone.

Performing the functions as described above based on the distance between the microphone and the hub can advantageously be used to eliminate unwanted noise caused by inserting the microphone and removing the microphone from a slot in the hub.

FIG. 4B shows one example of performing steps 450 and 460 of method 400 illustrated in FIG. 4A, including step 450A for comparing the distance to one or more thresholds and step 460A for performing functions based on the comparison. Step 450A may follow one of the steps 410-440 and include sub-steps 451 and 452, and step 460A includes sub-steps 461 and 462.

At step 451, the microphone and/or the hub may determine (e.g., detect) whether the microphone crosses the distance threshold. For example, the microphone and/or the hub may store in memory one or more previous indications of the distance (e.g., received in previous performances of step 440) between the microphone and the hub and compare those previous indications to the most recent indication of the distance to detect changes in the distance. Based on detected changes in the distance, the microphone and/or the hub may determine whether a change in the distance crosses a distance threshold, for example, by changing from a distance below a threshold to above the threshold or by changing from a distance above a threshold to below the threshold. The microphone and/or the hub may average or filter the indications of distance over time to avoid momentary or false detections of a detected crossing of a threshold.

If, at step 451, the microphone and/or the hub determines that the microphone does not cross the distance threshold, the process proceeds to step 470 to repeat the process of FIG. 4A for receiving a new indication of distance and repeating the comparison.

If, at step 451, the microphone and/or the hub determines that the microphone crosses the distance threshold, the process proceeds to step 452, at which the microphone and/or the hub determines whether the distance of the microphone is increasing or decreasing, e.g., moving away from or nearer to the hub. The microphone crossing a proximity threshold distance and moving away from the hub may be interpreted as a user removing the microphone from the slot in the hub, and the microphone crossing a proximity threshold distance and moving closer to the hub may be interpreted as a user inserting (e.g., docking) the microphone into the slot in the hub.

Based on the microphone crossing the distance threshold (in step 451) and the distance increasing (e.g., moving away from the hub) (in step 452), the microphone and/or the hub may, at step 461, perform one or more undocking functions. For example, as described above with respect to step 460 in FIG. 4A, the microphone and/or the hub may enable the microphone, transition the microphone from a standby mode to an active mode, unmute the microphone (e.g. enable output of an audio signal to speakers), increase the volume linearly or according to some other function of a duration (e.g., fade in the volume), and/or join or enable an audio or video communication (e.g., a video conference).

Based on the microphone crossing the distance threshold (in step 451) and the distance decreasing (e.g., moving toward the hub) (in step 452), the microphone and/or the hub may, at step 462, perform one or more docking functions. For example, as described above with respect to step 460 in FIG. 4A, the microphone and/or the hub may disable the microphone, transition the microphone from an active mode to a standby mode, power the microphone off, mute the microphone (e.g. disable output of an audio signal to one or more speakers), decrease the volume linearly or according to some other function of time (e.g., fade out the volume), attenuate the output to a subset of speakers, and/or leave or end an audio or video communication (e.g., a video conference).

FIG. 4C shows another example of performing steps 450 and 460 of method 400 illustrated in FIG. 4A, including step 450B for comparing the distance to one or more thresholds and step 460B for performing functions based on the comparison. Step 450B may follow one of the steps 410-440 and include sub-step 453, and step 460B includes sub-steps 463 and 442. At step 453, the microphone and/or the hub may determine (e.g., detect) whether the microphone is at a distance from the hub that is greater than the distance threshold.

Based on the distance of the microphone being greater than the distance threshold (e.g., regardless of whether the distance is changing or crosses the threshold as in FIG. 4B), the microphone and/or the hub may, at step 463, perform one or more undocked functions. The undocked functions of step 463 may be similar to or the same as the undocking functions described above with respect to step 461 of FIG. 4B. For example, the microphone and/or the hub may set or maintain the microphone in powered-on, enabled, active, and/or unmuted modes, and/or actively regulate the volume (e.g., within a volume range based on feedback from speakers).

Based on the distance of the microphone being less than the distance threshold (e.g., regardless of whether the distance is changing or crosses the threshold as in FIG. 4B), the microphone and/or the hub may, at step 464, perform one or more docked functions. The docked functions of step 464 may be similar to or the same as the docking functions described above with respect to step 462 of FIG. 4B. For example, the microphone and/or the hub may set or maintain the microphone in powered-off, disabled, standby, and/or muted modes, and/or may charge the microphone (e.g., via charger IF 330 and 380).

FIG. 4D shows a further example of performing steps 450 and 460 of method 400 illustrated in FIG. 4A, including step 450C for comparing the distance to one or more thresholds and step 460C for performing functions based on the comparison. Step 450C may follow one of the steps 410-440 and include sub-step 454, and step 460C includes sub-steps 465-468.

At step 454, the microphone and/or the hub may determine (e.g., detect) whether the distance of the microphone to the hub decreases below a distance threshold. In some examples, step 454 may be performed in a similar manner to steps 451 and 452 of FIG. 4B.

Based on the distance decreasing below the distance threshold, the process proceeds to step 465, at which the microphone and/or the hub performs one or more docking or docked functions as previously described with respect to step 462 (FIG. 4B) and/or step 464 (FIG. 4C). Based on the distance decreasing below the distance threshold, at step 466, the microphone and/or the hub may further set a flag (e.g., a docked flag in a memory), indicating that the microphone is docked in a slot of the hub. From steps 465 and 466, the microphone and/or the hub may proceed to step 467.

If at step 454, the microphone and/or the hub has not detected that the distance of the microphone to the hub decreased below a distance threshold (e.g., because the distance was already previously below the threshold or is currently maintained above the threshold), then steps 465 and 466 may be skipped prior to proceeding to step 467.

At step 467, the microphone and/or the hub may determine (e.g., detect) whether the microphone has been undocked from the hub (e.g., removed from a slot in the hub). For example, the microphone and/or the hub may detect that the charge IF 330 of the microphone is decoupled from charter IF 380 in the hub or that a direct connection (e.g., a contact switch or communication link) has been disconnected or disengaged between the microphone and the hub. In some examples, step 467 is performed in the same or similar manner as step 450A (e.g., steps 451 and/or 452) or step 450B (e.g., step 453) as previously described. If at step 467, undocking of the microphone is not detected, the process may proceed to step 470 of process 400 in FIG. 4A. If at step 467, undocking of the microphone is detected, the microphone and/or the hub may clear the docked flag in step 468 and perform one or more undocking or undocked functions in step 469 prior to proceeding to step 470. The microphone and/or hub may perform in step 467 one or more undocking or undocked functions as previously described with respect to step 461 (FIG. 4B) and/or step 463 (FIG. 4C).

The various methods, devices, and systems described herein may enable a wireless microphone to perform functions autonomously based on the microphone. Being removed or inserted into a wireless hub or docking station. Advantageously, the docking/undocking of the microphone may be detected, and the functions performed before/after the microphone physically contacts the wireless hub, which avoids issues with noise and vibrations created do to the contact between the microphone and the hub/dock.

One or more aspects of the disclosure may be embodied in computer-usable data or computer-executable instructions, such as in one or more program modules, executed by one or more computers (e.g., processors 310, 360) or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium (e.g., memories 305, 355) such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. An audio device comprising a wireless microphone or a hub, wherein the wireless microphone and the hub are adapted to communicate with each other, and wherein the wireless microphone or the hub comprises:
at least one processor; and
memory having computer-executable instructions stored therein, wherein the computer-executable instructions, when executed by the at least one processor, cause the audio device to:
receive an indication of a distance between the wireless microphone and the hub;
compare the distance to a predetermined threshold; and
based on the comparing, perform one or more audio functions.

2. The audio device of claim 1, wherein the computer-executable instructions, when executed by the at least one processor, cause the audio device to:
determine, based on the comparing, that the distance between the wireless microphone and the hub decreased below the predetermined threshold; and
perform, based on the determination that the distance decreased below the predetermined threshold, the one or more audio functions.

3. The audio device of claim 2, wherein the one or more audio functions include muting the wireless microphone or decreasing a volume of the wireless microphone over a time duration.

4. The audio device of claim 3, wherein the computer-executable instructions, when executed by the at least one processor, cause the audio device to:
determine, based on the determination that the distance decreased below the predetermined threshold, that the wireless microphone is docked in the hub;
detect that the wireless microphone has been undocked from the hub; and
increase the volume of the wireless microphone based on the detection that the wireless microphone has been undocked from the hub.

5. The audio device of claim 2, wherein the one or more audio functions include muting the wireless microphone by reducing a volume of an audio signal output by the wireless microphone or the hub.

6. The audio device of claim 2, wherein the one or more audio functions include muting the wireless microphone before the wireless microphone contacts the hub.

7. The audio device of claim 1, further comprising an antenna, wherein the computer-executable instructions, when executed by the at least one processor, cause the audio device to:
detect a strength of a signal received by the antenna; and
determine, based on the strength of the signal, the distance between the wireless microphone and the hub.

8. The audio device of claim 1, wherein the computer-executable instructions, when executed by the at least one processor, cause the audio device to:
determine, based on the comparing, that the distance between the wireless microphone and the hub increased above the predetermined threshold; and
perform, based on the determination that the distance increased above the predetermined threshold, the one or more audio functions.

9. An audio system comprising:
a wireless microphone comprising:
one or more sound transducers,
a base,
a first antenna, and
first circuitry configured to generate an audio signal based on sound sensed via the one or more sound transducers and transmit the audio signal via the first antenna; and
a hub comprising:
a slot configured to receive the base of the wireless microphone,
a second antenna,
a data interface, and
second circuitry configured to receive the audio signal from the wireless microphone via the second antenna and transmit audio data based on the received audio signal from the data interface ;
wherein the first circuitry, the second circuitry, or a combination of the first circuitry and the second circuitry are further configured to:
determine a distance between the wireless microphone and the hub;
compare the distance to a predetermined threshold; and
based on the comparing, perform one or more audio functions.

10. The audio system of claim 9, wherein the first circuitry, the second circuitry, or a combination of the first circuitry and the second circuitry are further configured to:
determine, based on the comparing, that the distance between the wireless microphone and the hub decreased below the predetermined threshold; and
perform, based on the determination that the distance decreased below the predetermined threshold, the one or more audio functions.

11. The audio system of claim 10, wherein the one or more audio functions include muting the wireless microphone or decreasing a volume of the wireless microphone over a time duration.

12. The audio system of claim 11, wherein the first circuitry, the second circuitry, or a combination of the first circuitry and the second circuitry are further configured to:
determine, based on the determination that the distance decreased below the predetermined threshold, that the wireless microphone is docked in the hub;
detect that the wireless microphone has been undocked from the hub; and
increase the volume of the wireless microphone based on the detection that the wireless microphone has been undocked from the hub.

13. The audio system of claim 10, wherein the one or more audio functions include muting the wireless microphone by reducing a volume of the audio signal transmitted from the microphone or the audio data transmitted by the hub.

14. The audio system of claim 10, wherein the one or more audio functions include muting the wireless microphone before the wireless microphone contacts the hub.

15. The audio system of claim 9, wherein the first circuitry, the second circuitry, or a combination of the first circuitry and the second circuitry are further configured to:
detect a signal strength of the audio signal received by the second antenna or of another signal exchanged between the first antenna and the second antenna; and
determine, based on the signal strength, the distance between the wireless microphone and the hub.

16. The audio system of claim 9, wherein the first circuitry, the second circuitry, or a combination of the first circuitry and the second circuitry are further configured to:
determine, based on the comparing, that the distance between the wireless microphone and the hub increased above the predetermined threshold; and
perform, based on the determination that the distance increased above the predetermined threshold, the one or more audio functions.

17. A method of controlling a wireless microphone or a hub, the method comprising:
receiving an indication of a distance between the wireless microphone and the hub;
comparing the distance to a predetermined threshold; and
performing, by the wireless microphone or the hub, one or more audio functions based on the comparing.

18. The method of claim 17, further comprising:
determining, based on the comparing, that the distance between the wireless microphone and the hub decreased below the predetermined threshold; and
performing, based on the determining that the distance decreased below the predetermined threshold, the one or more audio functions.

19. The method of claim 18, wherein the one or more audio functions include muting the wireless microphone before the wireless microphone contacts the hub.

20. The method of claim 19, further comprising:
determining, based on the determining that the distance decreased below the predetermined threshold, that the wireless microphone is docked in the hub;
detecting that the wireless microphone has been undocked from the hub; and
increasing volume of the wireless microphone based on the detecting that the wireless microphone has been undocked from the hub.
